(19) United States
(12) Patent Application Publication
(10) Pub. No.: US 2010/0081445 A1
(43) Pub. Date: Apr. 1, 2010

(54) METHOD AND APPARATUS FOR INCREASING CONTROL CHANNEL CAPACITY IN GERAN

(75) Inventors: Behrouz Aghili, Commack, NY (US); Marian Rudolf, Montreal (CA); Stephen G. Dick, Nesconset, NY (US)

Correspondence Address: VOLPE AND KOENIG, P.C.;DEPT. ICC, UNITED PLAZA, SUITE 1600, 30 SOUTH 17TH STREET, PHILADELPHIA, PA, 19103, US

(73) Assignee: INTERDIGITAL PATENT HOLDINGS, INC., Wilmington, DE (US)

(21) Appl. No.: 12/566,126

(22) Filed: Sep. 24, 2009

Related U.S. Application Data
(60) Provisional application No. 61/100,570, filed on Sep. 26, 2008.

(51) Int. Cl. H04W 72/04

(52) U.S. Cl. 455/450

(57) ABSTRACT

A method and apparatus may be used for increasing control channel capacity in Global System for Mobile communications (GSM). In a first method, the Multi-User-Reusing-One-Slot or Voice Services Over Adaptive Multiuser Channels On One Slot (MUROS/VAMOS) concept may be applied to timeslots or bursts carrying a Stand Alone Dedicated Control Channel (SDCCH). In a second method, the control signaling needed to support call setup for voice traffic may be switched over to a MUROS/VAMOS-capable traffic channel as early as possible instead of being handled through the SDCCH. In a third method, the channel coding format of the signaling bursts and/or bursts sent and received on the allocated traffic or SDCCH timeslots or resources may be modified to provide for additional link robustness and to overcome an intrinsic penalty when allowing for two simultaneous wireless transmit/receive units (WTRUs) on a timeslot used for signaling. In a fourth method, a WTRU may notify the GSM network that the WTRU is MUROS/VAMOS capable.

### CROSS REFERENCE TO RELATED APPLICATIONS

This application claims the benefit of U.S. Provisional Application Ser. No. 61/100,570 filed on Sep. 26, 2008, which is incorporated by reference as if fully set forth.

### TECHNICAL FIELD

This application is related to wireless communications.

### BACKGROUND

Various approaches have been developed to allow multiple users to reuse a single timeslot in time slotted wireless systems, referred to as Multiple Users Reusing One Slot (MUROS) technologies or Voice Services Over Adaptive Multiuser Channels On One Slot (VAMOS). One such approach involves the use of orthogonal sub-channels (OSC). The OSC concept allows a wireless network to multiplex two or more wireless transmit/receive units (WTRUs) that are allocated the same radio resource (that is, time slot) and Global System for Mobile communication (GSM) channel, thus the capacity may be significantly improved for a number of available transceiver (TRX) hardware and possibly for the spectrum resource. Furthermore, such a feature may provide voice capacity improvement for both full rate and half rate channels.

MUROS/VAMOS proposes methods such that speech services carried on traffic channels may be provided to two or more users per timeslot simultaneously over the same physical channel or timeslot. Depending on the MUROS/VAMOS technique under consideration, one of the multiplexed users may be a legacy user. The legacy user may be implemented with or without single antenna interference cancelation (SAIC) or Downlink Advanced Receiver Performance (DARP) support. Accordingly, a new type of MUROS/VAMOS equipment that relies on DARP-like interference-type cancellation receivers would be desirable. Further, it would be desirable for the new MUROS/VAMOS equipment to support features such as additional training sequences.

In a GSM system, the cell configuration of the signaling resources and other essential system access parameters is broadcast as part of system information messages on the Broadcast Control Channel. The main signaling channels used in a GSM system to support call setup signaling are referred to as the Stand Alone Dedicated Control Channels (SDCCHs). The SDCCHs are typically used for registration purposes and for other services, such as transfer of short message service (SMS) messages and the activation or interrogation of Supplementary Services (SS). An operator may allocate a number of SDCCH resources based on the available number of channels/timeslots in the GSM cell, the expected number of calls and traffic channel allocations.

For example, in many common GSM deployments where a cell may be equipped with two to three transceivers (TRXs), typically one timeslot on a certain TRX may be allocated to support Control Channels such as the Synchronization Channel (SCH), Frequency Correction Channel (FCCH), Broadcast Control Channel (BCCH), Paging Channel (PCH), Access Grant Channel (AGCH), and Random Access Channel (RACH). A number of additional timeslots on this TRX in a number of frames occurring over a multi-frame period are allocated to carry SDCCHs used for call setup, SMS, and/or SS for the available traffic resources on the remaining TRXs. Specifically, one such normal configuration used by most operators is to allocate one timeslot for the SDCCH. It is worth noting that the SDCCH resources are time multiplexed over one or more consecutive 51-multi-frame periods leading to configurations that include eight available SDCCH sub-channels on the same timeslot.

FIG. 1 shows a Time Division Multiple Access (TDMA) frame mapping for control channels. It is known that SDCCH dimensioning is performed according to close capacity by using the distribution and occurrences of expected call arrivals or the distribution of call durations.

Since the advent of MUROS/VAMOS and increased voice capacity for the same number of traffic timeslots, the number of expected users that may simultaneously be supported on these traffic timeslots has been significantly increased. But, a significant portion of calls that would otherwise be supported in terms of traffic capacity will be blocked or experience an un-acceptable amount of call setup delay. It would therefore be desirable to dimension the capacity and allocation of accompanying SDCCH resources in the cell used for the call setup process.

Although much attention has been given to GSM design considerations for the MUROS/VAMOS concepts when used on traffic channels carrying voice, the existing state-of-the-art does not describe or address the detrimental impact of MUROS/VAMOS onto the signaling channels and their dimensioning in terms of availability and number of allocated channel/timeslot resources to support all the expected activities in the cell.

One possibility to increase the SDCCH signaling resources would be by simply allocating more timeslots for the SDCCHs. However, this approach has the negative impact of losing timeslot resources to accommodate the increased control signaling that would otherwise be used for traffic. Therefore, novel methods and procedures are sought to accommodate the increased traffic capacity of GSM cells using the MUROS/VAMOS concept on the Control Channels such as SDCCH, in order to minimize the number of simultaneously needed timeslot resources, or number of frames in a multi-frame, or channels, and to guarantee call setup, or SMS transfer delays, or SS access delays similar to state-of-the-art GSM systems and deployments.

### SUMMARY

A method and apparatus for increasing control channel capacity in a GSM system is disclosed. In a first method, the MUROS/VAMOS concept may be applied to timeslots or bursts carrying a SDCCH. The GSM network may use a timeslot allocated to carry control signaling traffic, supplementary services, or SMS, to simultaneously send more than one WTRU burst in a timeslot. In a second method, the control signaling to support call setup for voice traffic may be switched over to a MUROS/VAMOS-capable traffic channel as early as possible instead of being handled through the SDCCH. In a third method, the channel coding format of the signaling bursts and/or bursts sent and received on the allocated traffic or SDCCH timeslots or resources may be modified to provide for additional link robustness and to overcome an intrinsic penalty when allowing for two simultaneous WTRUs on a timeslot used for signaling. In a fourth method, a WTRU may notify the GSM network that the WTRU is MUROS/VAMOS capable.

### BRIEF DESCRIPTION OF THE DRAWINGS

A more detailed understanding may be had from the following description, given by way of example in conjunction with the accompanying drawings wherein:

FIG. 1 is a diagram of a TDMA frame mapping for control channels;

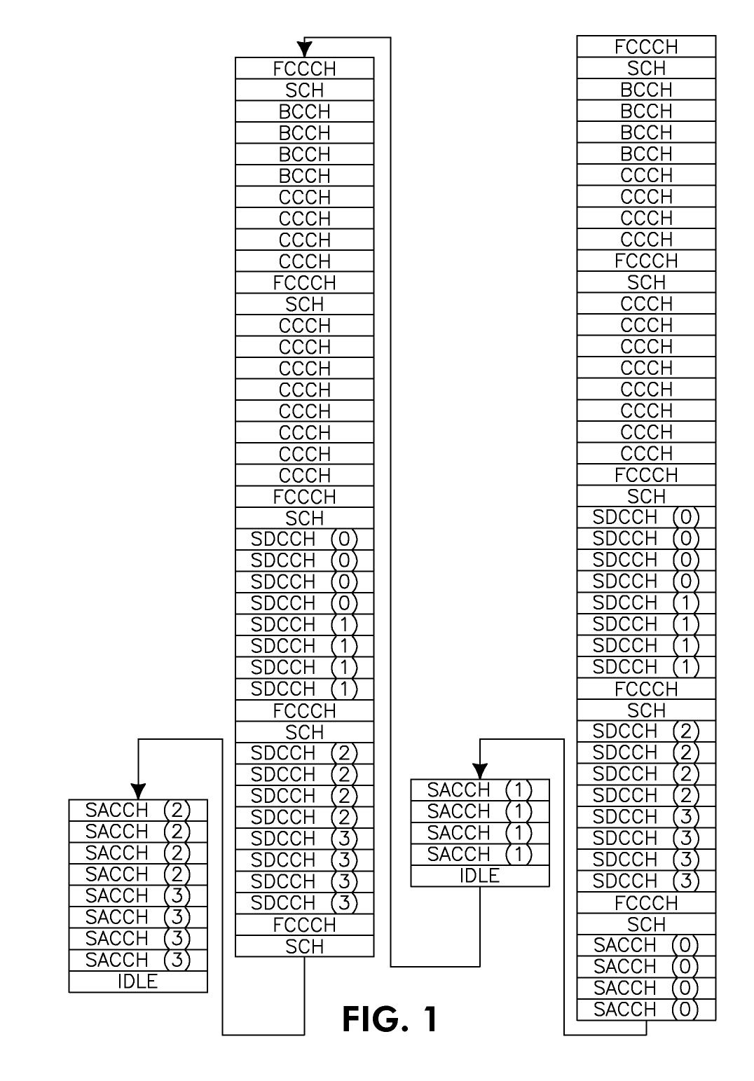

FIG. 2 is a diagram of a method applying the MUROS/VAMOS concept to timeslots or bursts that may carry the SDCCH;

FIG. 3 is a diagram of an example multiframe structure;

FIG. 4 is a flow diagram of control signaling to support call setup for voice traffic; and

FIG. 5 is a functional block diagram of a WTRU and a base station (BS) configured to apply the MUROS/VAMOS concept to timeslots or bursts that carry the SDCCH.

### DETAILED DESCRIPTION

When referred to hereafter, the terminology “wireless transmit/receive unit (WTRU)” includes but is not limited to a user equipment (UE), a mobile station, a fixed or mobile subscriber unit, a pager, a cellular telephone, a personal digital assistant (PDA), a computer, or any other type of user device capable of operating in a wireless environment. When referred to hereafter, the terminology “base station” includes but is not limited to a Node-B, a site controller, an access point (AP), or any other type of interfacing device capable of operating in a wireless environment. The embodiments described below apply equally to all technical proposals to realize the MUROS/VAMOS concept in a GSM system and are independent from the specifics of any of the embodiments implementing MUROS/VAMOS technology. Also, the presence of more sophisticated schemes such as Frequency-Hopping (FH) or Interference Diversity when choosing to pair different users in different timeslots or bursts in combination with the MUROS/VAMOS concept may not alter the MUROS/VAMOS operation concept.

In the uplink (UL) direction, the sub-channels may be separated using non-correlated training sequences. The first sub-channel may use existing training sequences, and the second sub-channel may use new training sequences, or vice versa. Alternatively, only new training sequences may be used on both of the sub-channels. Using OSC may enhance voice capacity with negligible impact to WTRUs and networks. OSC may be transparently applied for all Gaussian minimum shift keying (GMSK) modulated traffic channels (for example, for full rate traffic channels (TCH/F), half rate traffic channels (TCH/H), a related slow associated control channel (SACCH), and a fast associated control channel (FACCH)).

OSC increases voice capacity by allocating two or more circuit switched voice channels (that is, two or more separate calls) to the same radio resource. By changing the modulation of the signal from GMSK to quadrature phase shift keying (QPSK) (where one modulated symbol represents two bits), it is relatively easy to separate two users—one user on the X axis of the QPSK constellation and a second user on the Y axis of the QPSK constellation. A single signal contains information for two different users, each user allocated their own sub-channel. Using higher order modulation schemes, multiple users may share a single resource or timeslot.

In the downlink (DL), OSC may be realized in a base station (BS) using a QPSK constellation that may be, for example, a subset of an 8-PSK constellation used for enhanced general packet radio service (EGPRS). Modulated bits are mapped to QPSK symbols (“dibits”) so that the first sub-channel (OSC-0) is mapped to the most significant bit (MSB) and the second sub-channel (OSC-1) is mapped to the least significant bit (LSB). Both sub-channels may use individual ciphering algorithms, such as A5/1, A5/2 or A5/3. Several options for symbol rotation may be considered and optimized by different criteria. For example, a symbol rotation of 3π/8 would correspond to EGPRS, a symbol rotation of π/4 would correspond to π/4-QPSK, and a symbol rotation of π/2 may provide sub-channels to imitate GMSK. Alternatively, the QPSK signal constellation may be designed such that it resembles a legacy GMSK modulated symbol sequence on at least one sub-channel.

Several reasons favor QPSK as a choice for the MUROS/VAMOS modulation format. First, QPSK offers robust signal-to-noise ratio (SNR) versus bit error rate (BER) performance. Second, QPSK may be realized through existing 8-PSK-capable RF hardware. And third, QPSK burst formats have been introduced for Release 7 EGPRS-2 for Packet-Switched Services.

An alternate approach of implementing MUROS/VAMOS in the downlink involves multiplexing two or more WTRUs by transmitting two or more individual GMSK-modulated bursts per timeslot. As this approach causes increased levels of inter-symbol interference (ISI), an interference-cancelling technology such as DARP Phase I or Phase II may be required in the receivers. Typically, during the OSC mode of operation, a base station (BS) applies DL and UL power control with a dynamic channel allocation (DCA) scheme to keep the difference of received downlink and/or uplink signal levels of co-assigned sub-channels within, for example, a±10 dB window. The targeted value may depend on the type of receivers multiplexed and other criteria. In the uplink, each WTRU may use a normal GMSK transmitter with an appropriate training sequence. The BS may employ interference cancellation or joint detection type of receivers, such as a space time interference rejection combining (STIRC) receiver or a successive interference cancellation (SIC) receiver, to receive the orthogonal sub-channels used by different WTRUs.

OSC may be used in conjunction with frequency-hopping or user diversity schemes, either in the DL, in the UL, or both. For example, on a per-frame basis, the sub-channels may be allocated to different pairings of users, and pairings on a per-timeslot basis may recur in patterns over prolonged period of times, such as several frame periods or block periods.

Statistical multiplexing may further be used to allow more than two WTRUs to transmit using two available sub-channels. For example, four WTRUs may transmit and receive speech signals over a 6-frame period by using one of two sub-channels in assigned frames.

An extension of the baseline concept called the α-QPSK modulation scheme has been introduced. The α-QPSK modulation scheme suggests a simple means of power control for the in-band and quadrature components of the QPSK symbol constellation. By using an a parameter, the relative power on the MUROS/VAMOS timeslot allocated to the first versus the second sub-channel on the timeslot may be adjusted in a range of ±10-15 dB relative to each other. Using this approach, the absolute power allocated by the transmitter to the composite MUROS/VAMOS transmission may not require a precise ½ power for each user (equivalent to relative power of sub-channel 1/power sub-channel 2 at 0 dB). Other more desirable power ratios may be achieved, such as when one of the MUROS/VAMOS sub-channel (user) is in better signal conditions than the other user, and a power ratio of −3 dB (or higher) would result in better performance for the weaker MUROS/VAMOS user. Together with the absolute transmission power setting of the MUROS/VAMOS composite signal on the timeslot, the α-QPSK concept may result in a relative power control component for MUROS/VAMOS users.

Another possible extension of this baseline OSC concept suggests multiplexing of more than just a simple fixed pair of users into the very same allocated burst by extending the concept to statistical multiplexing of more than just two users over a period of at least several frames in a GSM multi-frame structure. At any given point in time (that is, any “burst”), not more than two users may transmit using the two available sub-channels of the OSC burst. However, when using Half Rate (HR) codecs (any WTRU required to transmit/receive one out of two frames), statistical multiplexing of more than just two users may be achieved. For example, four users may transmit/receive their HR speech signals over any given six frame period using one of the two available OSCs per burst, and by transmitting only in their assigned frames.

An even further possible modification to the baseline OSC concept suggests that re-use of GSM FH techniques would result in both interference averaging and the discontinuous transmission (DTX) gains for OSC and non-OSC users, with gains spread relatively equally amongst the WTRUs in the cell. Similar to the first possible modification, in any given burst (i.e., timeslot) not more than two users will transmit using the two available sub-channels of the OSC burst. However, by assigning different frequency-hopping sequences/Mobile-Allocation-Index-Offset's (MAIO's) to the different WTRUs in the cell, any WTRU may be paired with another WTRU on the next occurrence of a burst. The pattern may repeat after a certain number of frames, as a function of the FH-list. Note that this may be applicable to both DL and UL directions.

With regard to the UL direction, the MUROS/VAMOS concepts and/or extensions including the Frequency-Hopping concept for statistical multiplexing handsets suggest using normal GMSK transmission with different training sequences on the same time slot to allow the BS to distinguish between the two transmissions. Each of the two or more WTRUs may transmit a legacy GMSK modulated burst, unlike the OSC DL which may use QPSK. It may be assumed that the BS uses either STIRC or SIC receiver to receive orthogonal sub-channels used by different WTRUs.

With respect to the second technical concept referring to Release 6 DARP-type I receiver implementations in WTRUs, MUROS/VAMOS suggests that speech services may be provided to two or more users simultaneously over the same physical channel, or timeslot. One of these multiplexed users may be a legacy user. The legacy WTRU may be either with or without SAIC or DARP support implemented. Similarly, a new type of MUROS/VAMOS equipment may rely on DARP-like interference-type cancelation receivers. In addition, new MUROS/VAMOS equipment may be expected to support features such as extended training sequences.

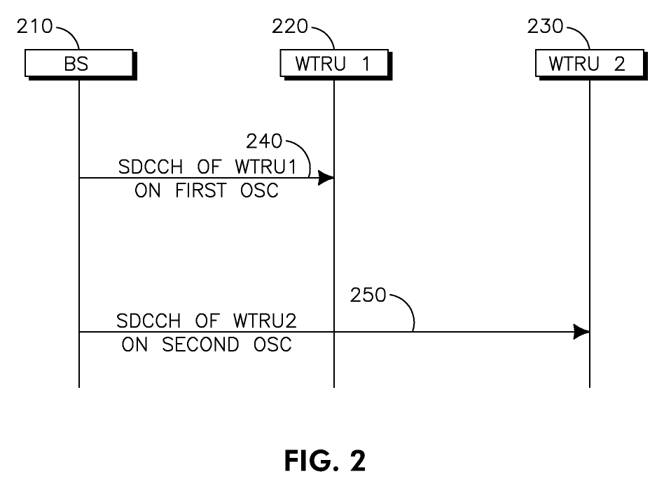

FIG. 2 is a diagram of a first method where the MUROS/VAMOS concept may be applied to timeslots or bursts that carry the SDCCH. The SDCCH timeslots that carry signaling may use a distinct and different burst encoding and protocol format compared to traffic timeslots that carry voice. In particular, the GSM network may include a BS 210 that may use a timeslot allocated to carry control signaling traffic, supplementary services, or SMS to simultaneously send more than one user's burst, for example WTRU1 220 and WTRU2 230, in such a timeslot.

For example, using QPSK or a derivative modulation type, a SDCCH of a first user may be carried on a first OSC in a timeslot designated to carry a SDCCH 240, while a SDCCH of a second user is carried on a second sub-channel in this timeslot 250 using different constellation points or complementary subset mappings of the modulated symbol stream. This concept may extend to other modulation schemes, such as for example, 16 QAM and so forth, or the individual sub-channels are created by simultaneously sending GMSK-modulated bursts to two users. Additionally, or in conjunction, the individual OSCs created on such a timeslot may also be differentiated by the use of, for example, different training sequences to aid the channel estimation process.

The method to create and support these OSCs on some or all of the SDCCH-designated timeslot resources in DL and UL may be identical or may be UL or DL specific. For example, QPSK or a derivative of it may be used to create OSCs in the DL, whereas the corresponding UL transmissions by the individual users use GMSK-modulated bursts, and may be detected using techniques such as IRC on the network side.

Using this method, the number of available SDCCH resources may be doubled through the availability of more than one OSC per SDCCH timeslot. Accordingly, the capacity is upscaled to match signaling traffic with increasing voice traffic.

In one embodiment, a GSM cell may allow for MUROS/VAMOS operation on all SDCCH resources. In another embodiment, a GSM cell may allow for MUROS/VAMOS operation on certain selected SDCCH resources, but not necessarily all of them. It should be noted that SDCCH resources may correspond to certain occurrences of frequency channels, timeslots (or bursts), and/or a combination of multi-frame occurrences of the frequency channels, timeslots or bursts.

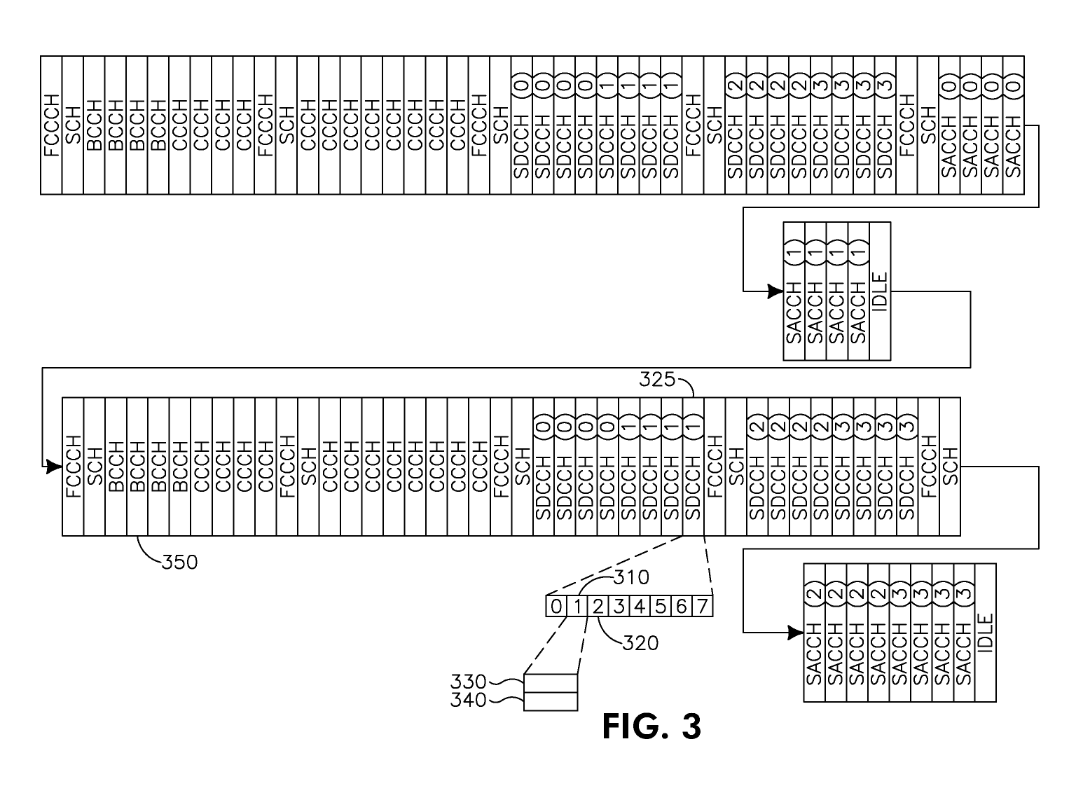

FIG. 3 is a diagram of an example multiframe structure 300. Referring to FIG. 3, if timeslots one 310 and two 320 on a channel occurring in a number of frames recurring in the multi-frame structure are reserved for SDCCH usage 325, timeslot one may be allocated to carry SDCCHs for two users using MUROS/VAMOS on either available sub-channel OSC-0 330 or OSC-1 340. However, timeslot two 320 may be configured to use SDCCH as in typical GSM systems (or, a single user burst per timeslot). This approach may advantageously be used for link performance reasons, or when a MUROS/VAMOS technique may not fully support the presence of a timeslot of a legacy GSM WTRU, such as a conventional receiver without interference cancellation capabilities of the receiver. It may be apparent to someone skilled in the art that the above example may be extendable to a different number of SDCCH timeslots or the partitioning of those timeslots.

In another embodiment, a GSM cell may allow for MUROS/VAMOS operation on either some or all of the SDCCH resources, but restrict a certain WTRU to the use of specific OSCs. The SDCCH resources may be channels, timeslots, bursts, or multi-frame occurrences of these resources. This approach may advantageously be used in cases where the link performance of legacy equipment may depend on its ability to decode legacy burst formats, such as a function of symbol rotation, or the Training Sequence used on the burst carrying SDCCH information.

The GSM access network and/or the WTRU may implement a procedure by which the configuration and access parameters of the SDCCH resources and the possibility to support more than one burst per SDCCH timeslot may be made known through signaling or through an application of a ruleset known to transmitter and receiver.

In one embodiment, the allocation and/or occurrences of SDCCH resources and the availability of MUROS/VAMOS OSCs on some or all of these SDCCH resources may be communicated through an extension of System Information on the BCCH.

In another embodiment, the allocation, availability, and/or occurrences of SDCCH resources and the availability of MUROS/VAMOS OSCs may be performed through Immediate Assignment messages.

For example, the GSM access network may signal the applicable or to be assigned burst formats, and/or allowed training sequence or training sequence codes (or the ones in use) for the SDCCH resources reserved in the cell, such as timeslots, channel numbers, frame occurrences, and/or the MUROS/VAMOS OSC on these, or equivalent. The WTRU may implement a procedure by which access to the DL and/or UL SDCCH may be configured as a function of the received configuration information from the access network.

In a second method, the control signaling to support call setup for voice traffic may be switched over to a MUROS/VAMOS-capable traffic channel or timeslot resource as early as possible instead of being handled through the SDCCH. One advantage of this method is that the overall number of signaling exchanges for execution over the SDCCH may be heavily reduced. Therefore, an SDCCH may be freed up earlier compared to typical techniques. Accordingly, by reducing the number of message exchanges taking place over the actual SDCCH-designated resources and shifting either all or a portion thereof off to traffic resources, the capacity problem on the SDCCHs may be alleviated.

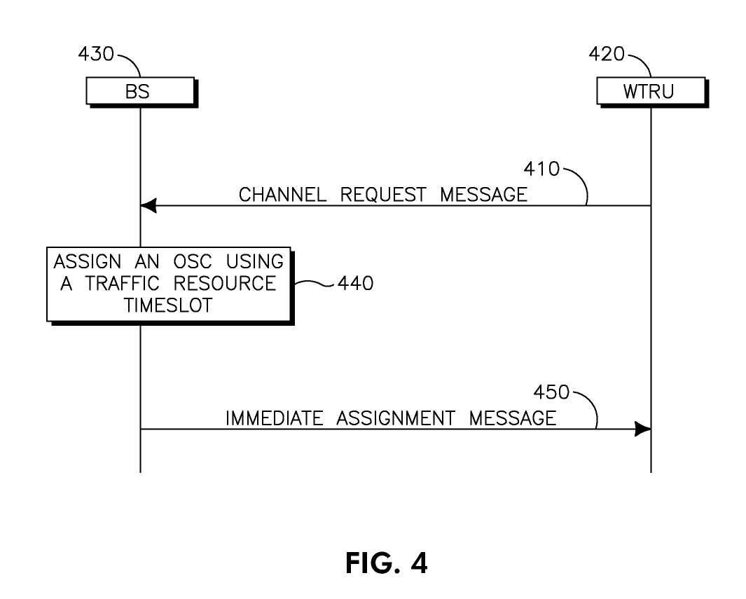

FIG. 4 is a flow diagram of control signaling to support call setup for voice traffic. In one embodiment, upon reception of a Channel Request message 410 from a WTRU 420, a BS 430 in the GSM network may assign a MUROS/VAMOS OSC using a timeslot that may belong to a traffic resource in the cell. The BS 430 may send a response using an Immediate Assignment message 450 on the timeslot to the WTRU 420. The traffic resource may either be un-allocated (and therefore presently unused), or the traffic timeslot may be in use by another voice user.

Extending the example when the Immediate Assignment Message may be used, the GSM network may indicate to the WTRU that the Channel Type for the assigned traffic resource is Control-type. After the initial signaling is executed, the network may then at some point in time change the channel mode from Control-type, or Signaling to Traffic-type, or Speech, by sending the Channel Mode Modify message. Note that the WTRU may remain on the same resource, but may use the resource as a signaling channel first, and then switch to use it as a traffic channel at a later point in time. By advantageously using the MUROS/VAMOS capability implemented in the WTRU and the network, the signaling traffic for call setup purposes may be carried over a traffic resource, even while another call of another user may be simultaneously supported on that traffic resource.

It would be apparent to someone skilled in the art that the above procedure may be modified to execute the switch from a dedicated stand-alone signaling resource, such as a SDCCH, to a traffic timeslot at some later point in time during the call establishment phase.

For example, the GSM access network may signal the applicable or to be assigned burst formats, and/or allowed training sequence or training sequence codes for the traffic timeslot, such as timeslot, channel number, FH parameters, frame occurrences, and/or the MUROS/VAMOS OSC, or equivalent. The WTRU may implement a procedure by which access to the DL and/or UL traffic resource is configured as a function of the received configuration information from the access network.

In a third method, the channel coding format of the signaling bursts and/or bursts sent and received on the allocated traffic or SDCCH timeslots or resources may be modified to provide additional link robustness and to overcome the intrinsic 3 dB link penalty when allowing for two simultaneous users on a timeslot used for signaling.

In one embodiment, when signaling is switched early and carried over a MUROS/VAMOS traffic resource, the channel coding of the signaling bursts may increase to provide an offset in channel decoding performance and to overcome the intrinsic link penalty when using a MUROS/VAMOS resource.

In another embodiment, a more robust channel coding on the signaling bursts may be achieved through repetition of either all or a selected subset of coded bits during the burst mapping process. Alternatively, a more robust coding of the signaling bursts may be performed through repetition of a signaling block (usually, 4 bursts), or by decreasing the channel coding rate (ratio of information bits over channel coded bits) when compared to the coding rate used for signaling bursts in use in a typical GSM system.

In yet another embodiment, signaling bursts or blocks may be sent on the MUROS/VAMOS-capable traffic timeslots by allowing reception and/or transmission in a selected subset of frames in the multi-frame structure only. For example, by designating signaling bursts to only transmit in the other user's Idle Frames, either the number of available channel bits may be increased or a lower order modulation type may be used, both of which increase the decoding performance for the bursts.

The use and applicability of a more robust coding scheme applied to the signaling bursts or blocks may be configured by the GSM network through the use of signaling messages, such as on the Broadcast Channel, or through the Immediate Assignment Message and so forth.

In order for above techniques to function properly, the network may be notified (by the WTRU) that the WTRU is MUROS/VAMOS capable. For example, the WTRU may notify the network that the WTRU is MUROS/VAMOS capable by sending the WTRU's MUROS/VAMOS capability as part of or contained in the RACH when the WTRU sends the Channel Request Message to the network.

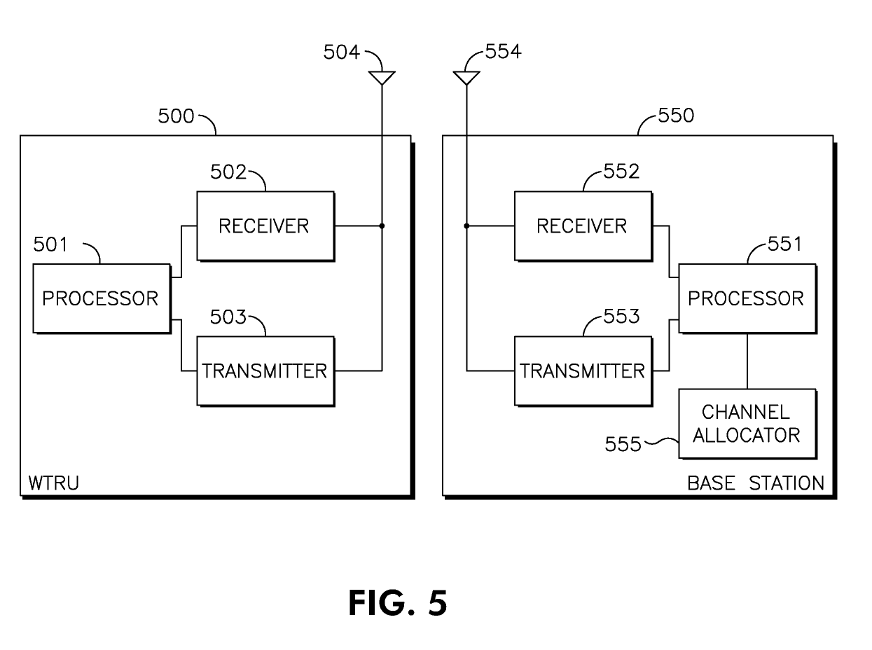

FIG. 5 is a functional block diagram of a WTRU 500 and a BS 550 configured in accordance with the methods described above. The WTRU 500 includes a processor 501 in communication with a receiver 502, transmitter 503, and antenna 504.

The processor 501 may be configured to apply the MUROS/VAMOS concept on a Control Channel such as a SDCCH as described above. The BS 550 includes a processor 551 in communication with a receiver 552, transmitter 553, antenna 554, and a channel allocator 555. The channel allocator 555 may be part of the processor 551, or it may be a separate unit in communication with the processor 551. The channel allocator 555 may be configured to apply the MUROS/VAMOS concept on a Control Channel such as a SDCCH as described above. The WTRU 500 may include additional transmitters and receivers (not depicted) in communication with the processor 501 and antenna 504 for use in multi-mode operation, as well as other components described above. The WTRU 500 may include additional optional components (not depicted) such as a display, keypad, microphone, speaker, or other components.

Although features and elements are described above in particular combinations, each feature or element can be used alone without the other features and elements or in various combinations with or without other features and elements. The methods or flow charts provided herein may be implemented in a computer program, software, or firmware incorporated in a computer-readable storage medium for execution by a general purpose computer or a processor. Examples of computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine.

A processor in association with software may be used to implement a radio frequency transceiver for use in a wireless transmit receive unit (WTRU), user equipment (UE), terminal, base station, radio network controller (RNC), or any host computer. The WTRU may be used in conjunction with modules, implemented in hardware and/or software, such as a camera, a video camera module, a videophone, a speakerphone, a vibration device, a speaker, a microphone, a television transceiver, a hands free headset, a keyboard, a Bluetooth® module, a frequency modulated (FM) radio unit, a liquid crystal display (LCD) display unit, an organic light-emitting diode (OLED) display unit, a digital music player, a media player, a video game player module, an Internet browser, and/or any wireless local area network (WLAN) or Ultra Wide Band (UWB) module.

What is claimed is:

1. A method for control channel operation comprising:
generating a multiframe comprising at least one control frame, wherein the at least one control frame is designated to carry a Stand Alone Dedicated Control Channel (SDCCH) and contains a timeslot having a first orthogonal sub-channel (OSC) and a second OSC;
allocating the SDCCH to carry control signaling traffic; and
transmitting the multiframe.

2. A method of claim 1 further comprising:
modulating a first wireless transmit/receive unit (WTRU) SDCCH on the first OSC in the timeslot; and
modulating a second WTRU SDCCH on the second OSC in the timeslot using a different constellation point or complementary subset mapping of the modulated SDCCH than for the first OSC.

3. The method of claim 2 wherein the first and second OSCs in the timeslot are differentiated by the use of different training sequences.

4. The method of claim 1 wherein the OSCs on the SDCCH-designated timeslot in the downlink and uplink are the same.

5. The method of claim 1 wherein the OSCs on the SDCCH-designated timeslot in the downlink and uplink are different.

6. The method of claim 1 further comprising:
configuring the first timeslot to carry SDCCHs for two wireless transmit/receive units (WTRUs) using the first and second OSCs; and
configuring a second timeslot to carry an SDCCH for one WTRU.

7. The method of claim 1 further comprising:
transmitting system information on a Broadcast Control Chanel (BCCH) to a wireless transmit/receive unit (WTRU), wherein the system information includes the allocation or occurrences of SDCCH resources and availability of OSCs.

8. The method of claim 1 further comprising:
transmitting an immediate assignment message to a wireless transmit/receive unit (WTRU) that contains system information and includes the allocation or occurrences of SDCCH resources and availability of OSCs.

9. A method for increasing control system capacity in a GSM network using Multi-User-Reusing-One-Slot (MUROS/VAMOS), the method comprising:
receiving a request message from a wireless transmit/receive unit (WTRU); and
assigning an orthogonal sub-channel (OSC) using a response message on a timeslot belonging to a traffic resource.

10. The method of claim 9 wherein the traffic resource is a non-allocated traffic resource.

11. The method of claim 9 wherein the timeslot is used by more than one WTRU.

12. A wireless transmit/receive unit (WTRU) comprising:
a receiver configured to receive a multiframe comprising at least one control frame, wherein the at least one control frame is designated to carry a Stand Alone Dedicated Control Channel (SDCCH) and contains a timeslot having a first orthogonal sub-channel (OSC) and a second OSC; and
a processor configured to decode one of the first or second OSCs and recover the control frame.

13. The WTRU of claim 12 wherein the receiver is configured to receive system information on a Broadcast Control Chanel (BCCH), the system information including an allocation or occurrences of SDCCH resources and availability of OSCs.

14. The WTRU of claim 12 wherein the receiver is configured to receive an immediate assignment message that contains system information and includes the allocation or occurrences of SDCCH resources and availability of OSCs.

15. A base station (BS) comprising:
a channel allocator configured to
generate a multiframe comprising at least one control frame, wherein the at least one control frame is designated to carry a Stand Alone Dedicated Control Channel (SDCCH) and contains a timeslot having a first orthogonal sub-channel (OSC) and a second OSC, and
allocate the SDCCH to carry control signaling traffic; and
a transmitter configured to transmit the multiframe.

16. The BS of claim 15 further comprising:
a processor configured to
modulate a first wireless transmit/receive unit (WTRU) SDCCH on the first OSC in the timeslot; and
modulate a second WTRU SDCCH on the second OSC in the timeslot using a different constellation point or complementary subset mapping than for the first OSC.

17. The BS of claim 16 wherein the processor is configured to use different training sequences to modulate the first and second OSCs in the timeslot.

18. The BS of claim 15 wherein the channel allocator is configured to configure a first timeslot to carry SDCCHs for two wireless transmit/receive units (WTRUs) using a first and second OSC, and to configure a second timeslot to carry an SDCCH for one WTRU.

19. The BS of claim 15 wherein the transmitter is configured to transmit system information on a Broadcast Control Channel (BCCH) to a wireless transmit/receive unit (WTRU), wherein the system information includes an allocation or occurrences of SDCCH resources and availability of OSCs.

20. The BS of claim 15 wherein the transmitter is configured to transmit an immediate assignment message to a wireless transmit/receive unit (WTRU) that contains system information and includes an allocation or occurrences of SDCCH resources and availability of OSCs.
